(19) United States
(12) Patent Application Publication
(10) Pub. No.: US 2003/0163698 A1
(43) Pub. Date: Aug. 28, 2003

(54) Password-based authentication protocol secure against server's dictionary attack

(76) Inventors: Jeeyeon Kim, Seoul (KR); Seungjoo Kim, Seoul (KR); Hyun-Jo Kwon, Seoul (KR); Hae-Ryong Park, KwangJoo (KR); Hong Geun Kim, Kyungki-do (KR)

Correspondence Address: VOLENTINE FRANCOS, P.L.L.C., Suite 150, 12200 Sunrise Valley Drive, Reston, VA, 20191, US

(21) Appl. No.: 10/325,904

(22) Filed: Dec. 23, 2002

(30) Foreign Application Priority Data
Feb. 26, 2002 (KR) 2002-0010313

(51) Int. Cl. H04L 9/00

(52) U.S. Cl. 713/171

(57) ABSTRACT

The present invention discloses a password-based authentication protocol wherein an authentication key is generated with an individual private key of the key servers and a public key of the group of the key servers, which do not store the user's password, and thereby it is possible to protect against a camouflaging server's dictionary attack for accessing the user's password.

### CROSS-REFERENCES TO RELATED APPLICATIONS

This application relies for priority upon Korean Patent Application No.2002-0010313, filed on Feb. 26, 2002, the contents of which are hereby incorporated by reference herein in their entirety as if fully set forth herein.

### TECHNICAL FIELD

The present invention relates to a protocol for the authentication of a user, and more specifically to a password-based protocol secure against a server's dictionary attack.

If an application server is to be accessed for a network service, it is necessary for a terminal to succeed in an authentication process from the application server.

In this case, the authentication process implies a step of verifying if the accessing counterpart is a really authentic one whom the party intends to communicate with.

The approaches for user authentication can be classified into three categories depending upon a basis element of an authenticating process. An approach is a biometric authentication.

For instance, a tone of the voice, a radioscopy, or a fingerprint can be employed for the authentication of a user. Another approach is a token-based authentication.

For example, an ID (identification) card or a smart card personally carried by a user can be utilized for a safe authentication of a genuine user. The other approach is a knowledge-based authentication.

For instance, a password or a PIN (personal identification number) that is memorized by a user is frequently utilized for authentication.

Comparing the above-mentioned three kinds of approaches, it should be noted that both the first and the second approaches guarantee relatively a robust security despite of the cost expensiveness for the hardware implementation.

In the meanwhile, the third approach, which is based on knowledge such as password, has a merit of cost effectiveness because no further investment for hardware equipment is required.

As a consequence, a password-based authentication protocol is widely used as an essential technology for a roaming service, especially of an information protection company.

However, the password based authentication approach has a technical limitation because the password of a user tends to be selected with a combination of characters that is easy to be memorized, i.e. therefore with quite low entropy in terms of the quantity of information.

As a consequence, it is possible for an attacker to exhaustively guess the user's password by a dictionary attack and likely to determine the user's password if either the hash of the password and/or the ciphertext using the password is exposed to the attacker.

Here, the dictionary attack means that an attacker exhaustively guesses a user's password in accordance with a specific rule from the trial list of possible passwords.

In order to surmount the weakness of the password-based approach against a dictionary attack, it has been recommended to change the password from time to time and/or to use a longer and complicated combination of characters for a password.

However, the above-mentioned remedies cannot resolve the underlying issue of a dictionary attack on a user's password.

In 1992, S. M. Bellovin and M. Merrit proposed a password-based protocol secure against a dictionary attack for authentication and key exchange (“Password-based protocols secure against dictionary attacks,” Proceedings of the IEEE Symposium of Research in Security and Privacy, Oakland, May 1992).

The approach proposed by Bellovin and Merrit, however, still suffers from vulnerability against a dictionary attack.

In 1996, D. Jablon proposed a novel concept of SPEKE (strong password encrypted key exchange) secure against a dictionary attack, which is a further development of the previous approach of Bellovin and Merrit (“Strong password only authenticated key exchange,” Computer Communication Review, ACM SIGCOMM, Vol. 26, No. 5, pp.5-26, October 1996).

The afore-mentioned SPEKE is utilized for a roaming service by Entrust, which is a company for PKI (public key infrastructure). The SPEKE, however, still has a shortcoming that the attacker's acquisition of a user's password is possible if a server is attacked because the user shares the password with the server.

In order to resolve the above-mentioned issue of the vulnerability of the server against an attacker's dictionary attack, Jablon et. al. proposed a so-called extended password key exchange protocol wherein only a password verifier can be stored at a server for confirming a user's password (“Extended password key exchange protocols immune to dictionary attacks,” Proceedings of the Sixth Workshops on Enabling Technologies: Infrastructure for Collaborative Enterprises (WET-ICE '97), pp. 248-255, IEEE Computer Society, Jun. 18-20, 1997, Cambridge, Mass., USA).

The Jablon's approach, however, still suffers from a technical limit of a possible dictionary attack when password verifier is exposed to an attacker even if the password is concealed itself. Therefore, it is still necessary to come up with a novel method that ensures security and robustness against a dictionary attack for an approach based on a password verifier because the password verifier is shared with a server.

In the year of 2000, W. Ford and B. Kaliski from VeriSign proposed a novel and quite robust password-based protocol.

The proposed approach can be thought to be quite robust to some extent because a multiple of servers should be simultaneously attacked for the success of an attacker's exhaustive guessing of a user's password. The feature of the Ford-Kaliski approach is that the key is generated with the assistance of a multiple of servers (“Server-assisted generation of a strong secret from a password,” Proceedings of IEEE 9th International Workshops on Enabling Technologies: Infrastructure for Collaborative Enterprises, NIST, Gathersburg, Md., Jun. 14-16, 2000).

Since the degree of complexity due to its randomness of the generated key is higher than that of the user's password, it is the stronger and more secure against a dictionary attack. The above mentioned authentication protocol proposed by Ford and Kaliski is disclosed at the U.S. Patent Publication No. 2001/0055388A.

FIGS. 1A and 1B illustrates an initial registration process and an authentication process of a user in accordance with the prior art of Ford-Kaliski, respectively.

Referring to FIG. 1A, it is assumed that a server authentication and a secret channel have been set up for an initial registration process. The parameters cited in the following description can be summarized as the following.

The letter p represents a prime integer wherein p=2q+1 (q is a large prime integer), while the letter g represents a primitive element of the group and has a relationship of order (g)=q. Further, f is a function that maps passwords to elements of multiplicative order q in Zₚ*.

In addition, KDF( ) is a computing function for an authentication key, while OWF( ) is a one-way function. Further, PWD represents a user's password.

Referring to FIG. 1A again, w=f (PWD) is calculated at a user's terminal (10) with a user's password PWD and a pre-defined function f. Thereafter, a number k (1≦k≦q−1) is randomly selected and r (=w^{k} mod p) is calculated at the user's terminal (10).

Finally, the user's terminal 10 sends both the user's identifier A and the number r, namely (A, r) , to key servers KS₁, KS₂, . . . , KSₙ (100, 101, 102, 103) (steps S20, S21, S22, and S23).

In the meanwhile, each key server KSᵢ (i=1, 2, . . . , n) (100, 101, 102, 103) generates a random number dᵢ (1≦dᵢ≦q−1), respectively, for the user's terminal (10) and calculates a number Sᵢ, where Sᵢ=r^{d}^{ᵢ} mod p (i=1, 2, . . . , n).

Thereafter, (A, dᵢ) is stored at a database of each key server and each Sᵢ (i=1, 2, . . . , n) is sent to a user's terminal (10) (steps S24, S25, S26, and S27). Finally, a number Rᵢ (i=1, . . . , n) is calculated at the user's terminal (10) with use of the numbers Sᵢ (i=1, . . . , n) and a number k from the following relationship.

Rᵢ=Sᵢ^{l/k} mod p=w^{d}^{ᵢ} mod p (i=1, . . . , n) (1)

Thereafter, the user's terminal (10) calculates an authentication key K with a function of KDF( ).

K=KDF (R₁, . . . , Rₙ) (2)

Now, a series of numbers K₁, K₂, . . . , Kₘ are calculated at the user's terminal (10) with equation (3) and safely delivered to a set of application servers ASⱼ (j=1, . . . , m) (111, 112, 113).

Kⱼ=OWF (K, j) (j=1, . . . , m) (3)

It should be noted that a multiple of numbers Kⱼ (j=1, . . . , m) are delivered to a corresponding application servers ASⱼ (j=1, . . . , m) (111, 112, 113), respectively, only once during the step of a user's registration.

Each application server ASⱼ (j=1, . . . , m) (111, 112, 113) stores its own key Kⱼ (j=1, . . . , m) in a safe place. In some practical applications, it may be possible that the key servers and the application servers should be identical.

Now, the process for a user authentication according to the prior art can be understood with reference to FIG. 1B. Referring to FIG. 1B, a number w=f (PWD) is calculated at a user's terminal (10) with a function f and a password PWD for the user authentication.

Thereafter, a number k (1≦k≦q−1) is randomly selected and a number r is computed from a relationship of r=w^{k} mod p at the user's terminal (10). The user's identifier A and the number r, namely (A, r), are sent to each key server KS₁, . . . , KSₙ (100, 101, 102, 103) (steps S31, S32, S33, and S34).

Then the key server KSᵢ (i=1, . . . , n) (100, 101, 102, 103) extracts dᵢ from the database (A, dᵢ). Now, each key server KSᵢ calculates a set of numbers Sᵢ with dᵢ from the relationship of Sᵢ=r^{d}^{ᵢ} mod p, respectively, and transmits Sᵢ (i=1, . . . , n) to the user's terminal (10) (steps S35, S36, S37, and S38).

Finally, numbers Rᵢ are computed at the user's terminal (10) from the number k and Sᵢ (i=1, . . . , n) that has been received from the key servers KSᵢ (i=1, . . . , n) (100, 101, 102, 103).

Rᵢ=Sᵢ^{l/k} mod p=w^{d}^{ᵢ} mod p (i=1, . . . , n) (4)

The authentication key K and Kᵢ are computed using KDF and OWF at the user's terminal (10).

K=KDF (Rₗ, . . . , Rₙ) (5)

K=OWF (K, j) (j=1, . . . , m) (6)

In the meanwhile, a set of challenges cⱼ (1≦cⱼ≦q−1) are generated at each application servers ASⱼ (j=1, . . . , m) (111, 112, 113) and sent to the user's terminal (10) (steps S39, S40, and S41) Thereafter, the response OWF(Kⱼ, cⱼ) to each challenge cⱼ is computed at the user's terminal (10) and sent to the application servers ASⱼ (j=1, . . . , m) (111, 112, 113) (steps S42, S43, and S44).

Finally, the application server ASⱼ (j=1, . . . , m) (111, 112, 113) computes OWF (Kⱼ cⱼ) from the keys Kⱼ (j=1, . . . , m) stored at its database and then compare the computed value with the one that was sent from user's terminal (10) for the verification of authenticity.

In the foregoing paragraphs, both the initial registration process and the user authentication process of the Ford-Kaliski method have been explained in detail as a prior art.

The prior art as disclosed in Ford-Kaliski approach still has a shortcoming in that an attacker can get information that is enough for a dictionary attack if an attacker camouflages the key servers and/or the application servers. This is because the prior art does not include a step of authenticating the servers during the user authentication process.

Therefore, even the authors of the prior art, Ford and Kaliski, themselves pointed out the above-mentioned shortcoming at their published paper and made a recommendation to use an authentication protocol such as SSL (secure socket layer) for a tentative remedy.

The technical problems included in the Ford-Kaliski approach can be more easily understood with reference to FIGS. 2A and 2B. Referring to FIG. 2A, it is assumed that a couple of key servers and an application server are chosen for the simplicity of the explanation.

Now, when the numbers (A, r) are sent to key servers from the user's terminal (10), an attacker masquerading as key servers (200, 201) generates numbers d₁* and d₂*, and computes numbers S₁* and S₂*, which are to be transmitted to the user's terminal (10) (steps S52 and S53).

s₁*=r^{d}^{₁}* mod p (7)

s₂*=r^{d}^{₂}* mod p (8)

In this case, the user's terminal (10) is to compute an authentication key K* that is totally different from the genuine authentication key K generated during the initial registration process.

Furthermore, the keys K₁* and K₂* are also computed for a first application server and a second application server, respectively.

K₁*=OWF (K*, 1) (9)

K₂*=OWF (K*, 2) (10)

Now, if an attacker sends a challenge c₁* to the user's terminal (10) by camouflaging as an application server AS₁* (202) (step S61), the user's terminal (10) is deceived and provides the attacker with OWF (K₁*, c₁*) as a response (step S62).

Finally, the attacker (202) can try a dictionary attack with the following equation (11) from the information OWF (K₁*, c₁*) transmitted from the user's terminal (10).

OWF (K₁*, c₁*)=OWF (OWF (K*, 1), c₁*)=OWF (OWF (KDF (W^{d}^{₁}*, w^{d}^{₂}*), 1), c₁*)=OWF (OWF (KDF (f(PWD)^{d}^{₁}*, f(PWD)^{d}^{₂}*), 1), c₁*) (11)

In order to resolve the above-mentioned technical shortcoming, Ford and Kaliski recommend a conventional SSL to be used during the step of the user authentication.

### DISCLOSURE OF INVENTION

In view of these problems, there is a need in the art for a password-based protocol, especially for a protocol secure against a server's dictionary attack, which is not subject to these limitations.

Accordingly, it is an object of the present invention to provide a password-based authentication protocol secure against a server's dictionary attack.

It is also an object of the present invention to provide a password-based authentication protocol that does not need an additional use of SSL for the security against a server's dictionary attack.

Yet it is another object of the present invention to provide a password-based authentication protocol that enhances the computing efficiency for the generation of authentication keys as well as the security against a server's dictionary attack.

In accordance with the present invention, a method for password-based authentication includes the following steps.

A user's identifier A with the number s computed from a secret data that is learned by heart are sent to a multiple of key servers KSᵢ (i=1, . . . , n). Then each key server KSᵢ (i=1, . . . , n) computes Bᵢ (i=1, . . . , n) with its own key (xᵢ, i=1, . . . , n) and number s, followed by a step of sending the computed numbers Bᵢ (i=1, . . . , n) to the user's terminal (10) while the user's identifier A is stored at a database. The authentication key K is then generated with public key y of the group KSᵢ (i=1, . . . , n) and Bᵢ (i=1, . . . , n).

### BRIEF DESCRIPTION OF THE DRAWINGS

These and other more detailed and specific objects and features of the present invention are more fully disclosed in the following specification, references being had to the accompanying drawings, in which:

FIGS. 1A and 1B are schematic diagrams illustrating the initial user registration process and the authentication process, respectively, of Ford-Kaliski approach as a prior art

FIGS. 2A and 2B are schematic diagrams illustrating a shortcoming of Ford-Kaliski approach as a prior art.

FIG. 3A is a schematic diagram illustrating a step of initial user registration in accordance with the present invention.

FIG. 3B is a schematic diagram illustrating a step of authentication in accordance with the present invention.

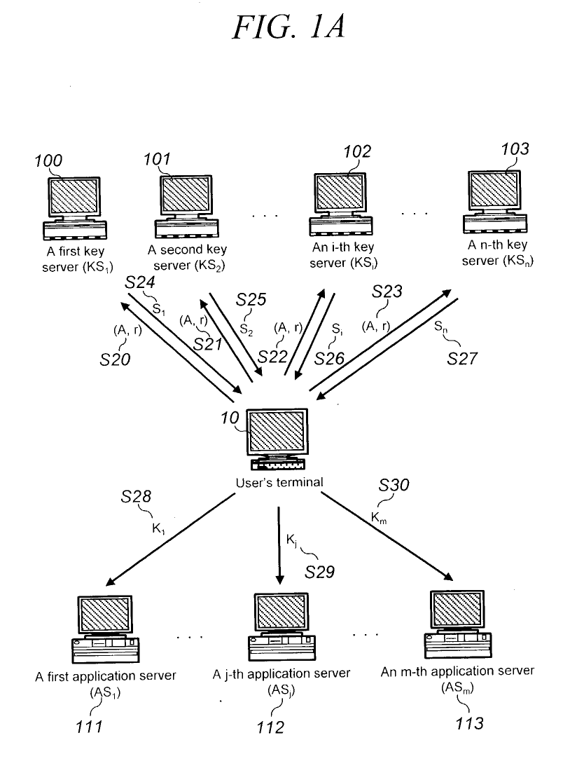

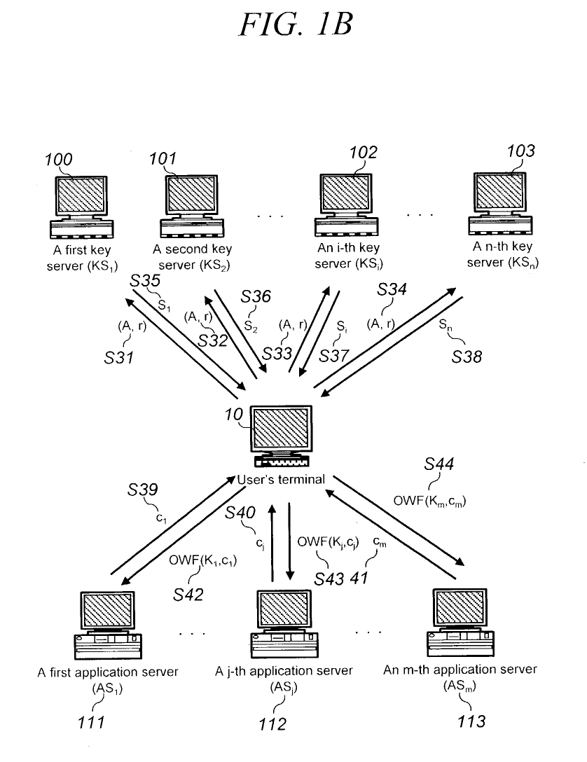

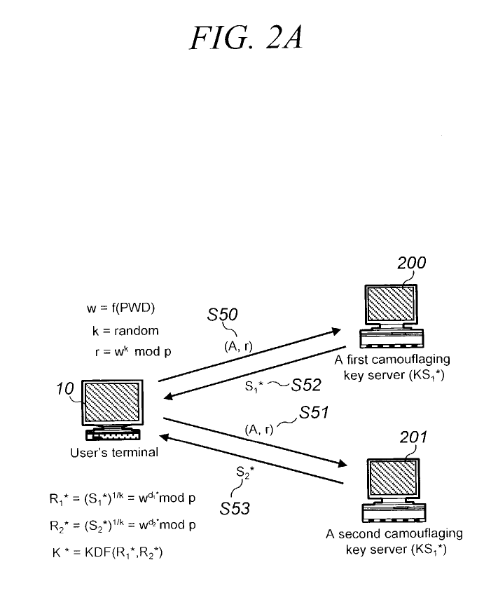

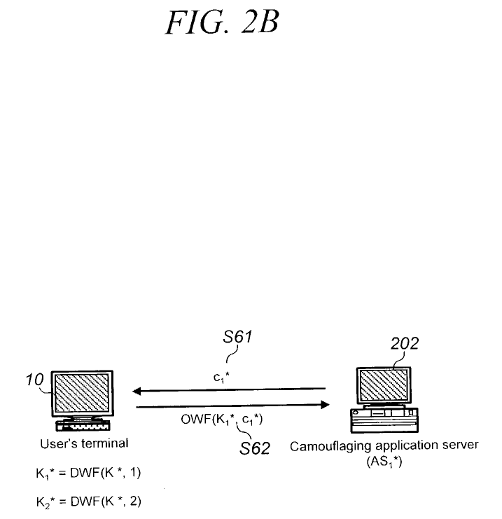

### DETAILED DESCRIPTION OF THE PREFERRED EMBODIMENTS OF THE INVENTION

One of the features of the present invention is that there are provided a set of private keys xᵢ (i=1, . . . , n) individually for each key server KS₁, KS₂, . . . , KSₙ, and a public key y of the group KS₁, KS₂, . . . , KSₙ. First of all, the parameters and terminology are briefly explained for the understanding of the specification.

In the followings, p is a prime integer where p=2q+1 (q is a large prime number). Additionally, g is a primitive element of the group with order (g)=q.

In the meanwhile, f is a function that maps passwords to elements of multiplicative order q in Zₚ*. Additionally, KDF ( ) is a function for computing an authentication key while OWF ( ) is a one-way function. The parameter PWD denotes a user's password while xᵢ (i=1, . . . , n) is a private key for individual key server KSᵢ (i=1, . . . , n) . Now, y is the public key of the group KSᵢ (i=1, . . . , n).

$$y = {\prod }_{i = 1}^{n} {g}^{{X}_{i}} mod p \qquad ( 12 )$$

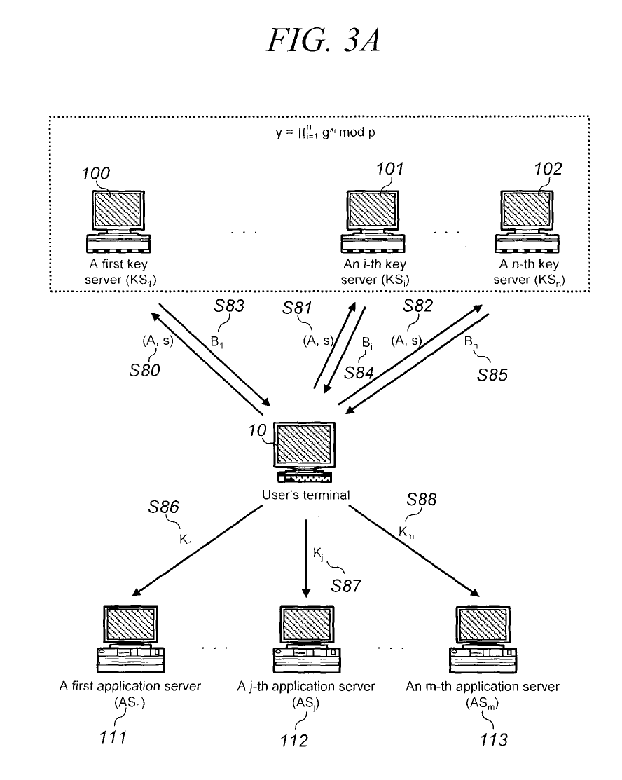

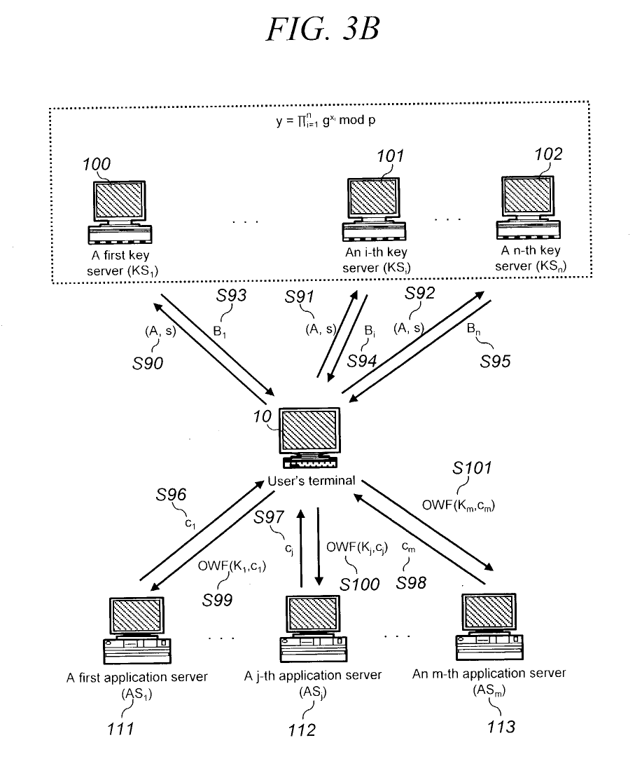

FIG. 3A is a schematic diagram illustrating a step of initial user registration in accordance with the present invention.

Referring to FIG. 3A, a number w is computed from a relation of w=f (PWD) at a user's terminal 10 with a user's password PWD and a function f. Thereafter, a number s is computed with a relationship of s=g^{z}w mod p from a randomly selected number z (1≦z≦q−1).

Finally, the computed number s with the user's identifier A is sent to the key server KSᵢ (i=1, . . . , n) (100, 101, 102) (steps S80, S81, and S82).

Thereafter, each key server KSᵢ (i=1, . . . , n) (100, 101, 102) computes Bᵢ=(s)^{x}^{ᵢ} mod p (i=1, . . . , n) , transmits Bᵢ to the user's terminal (10) and stores the user's identifier A at database (step S83, S84, and S85).

Now, the user's terminal (10) computes the authentication key K and Kⱼ (j=1, . . . , m) from the following equation.

$$K = KDF ( ( {\prod }_{i = 1}^{n} {B}_{i} ) / {y}^{z} mod p ) \qquad ( 13 )$$

Kⱼ=OWF (K, j) (j=1, . . . , m) (14)

The user's terminal (10) sends (A, Kⱼ) to each application server ASⱼ (j=1, . . . , m) (111, 112, 113) (steps S86, S87, and S88). Now detailed description regarding the user authentication process will be made in the following with reference to FIG. 3B.

Referring to FIG. 3B, the user's terminal (10) computes s=g^{z}w mod p (w=f(PWD) ) from the user's password PWD and a random number z. The computed number s with A are then sent to each key server KSᵢ (i=1, . . . , n) (100, 101, 102) (steps S90, S91, and S92).

Now, each key server KSᵢ (i=1, . . . , n) (100, 101, 102) checks if the user is the one who is registered at database, computes Bᵢ=(s)^{X}^{ᵢ} mod p (i=1, . . . , n), and sends Bᵢ to the user's terminal (10) (steps S93, S94, and S95).

Then, the user's terminal computes the authentication key K and Kⱼ (j=1, . . . , m) from the following equation.

$$K = KDF ( ( {\prod }_{i = 1}^{n} {B}_{i} ) / {y}^{z} mod p ) \qquad ( 15 )$$

Kⱼ=OWF (K, j) (j=1, . . . , m) (16)

Since the degree of complexity due to its randomness of the generated authentication key K is higher than that of the user's password, it is the stronger and more secure against a dictionary attack.

In the meanwhile, each application server ASⱼ (j=1, . . . , m) (111, 112, 113) generates a challenge cⱼ (1≦cⱼ≦q−1) and sends the challenge to the user's terminal (10) (steps S96, S97, and S98).

Thereafter, the user's terminal (10) computes a set of responses OWF (Kⱼ, cⱼ) to each challenge Cⱼ and send them to each application server ASⱼ (j=1, . . . , m) (111, 112, 113) (steps S99, S100, and S101).

In the meanwhile, each application server ASⱼ (j=1, . . . , m) (111, 112, 113) computes OWF (Kⱼ, cⱼ) (j=1, . . . , m) from Kⱼ (j=1, . . . , m) stored at database and compares the computed value with the received response in order to verify the authenticity of the user.

As a consequence, if the authentication of the user has been completed, the user's private key encrypted with Kⱼ is then forwarded to the user's terminal. Then the user can utilize the private key to perform the cryptographic service such as a digital signature.

As explained in the foregoing, the password-based protocol in accordance with the present invention can efficiently compute the authentication key K even if the number of key server is increased.

This is because the protocol in accordance with the present invention requires only a couple of exponent calculation and subsequent (n+1) times of multiplication while the prior art of Ford-Kaliski approach needs (n+1) times of exponent calculation.

Furthermore, since the public key y of the group of key servers and a secret random number z are used during the step of computing the authentication key, a camouflaging server that is unaware of a private key of each key server can not get information to mount a dictionary attack on the user's password.

Although the invention has been illustrated and described with respect to exemplary embodiments thereof, it should be understood by those skilled in the art that various other changes, omissions and additions may be made therein and thereto, without departing from the spirit and scope of the present invention.

Therefore, the present invention should not be understood as limited to the specific embodiment set forth above but to include all possible embodiments which can be embodies within a scope encompassed and equivalents thereof with respect to the feature set forth in the appended claims.

What is claimed is:

1. A method of deriving an authentication key K from a secret data that can be memorized by a user, the method comprising the steps of:
(a) transmitting the user's identifier A and a number s computed from said secret data to each key server KSᵢ (i=1, . . . , n), respectively;
(b) transmitting a number Bᵢ (i=1, . . . , n), which has been computed from the received number s and its own private key xᵢ (i=1, . . . , n) at each key server KSᵢ (i=1, . . . , n), to said user's terminal and storing said user's identifier A at database of each key server KSᵢ (i=1, . . . , n) ; and
(c) generating an authentication key K from Bᵢ (i=1, . . . , n), which has been sent from said each key server, and a public key y of the group of said key servers.

2. The method as set forth in claim 1 wherein said secret data comprises a PIN (personal identification number) or a password.

3. The method as set forth in claim 1 wherein said public key of the group KSᵢ, . . . , KSₙ is computed from the relationship of y=
$$y = {\prod }_{i = 1}^{n} {g}^{{X}_{i}} mod p$$
g^{X}^{ᵢ} mod p (g is a primitive element of the group and order(g)=q, p is a prime integer with p=2q+1, q is a large prime number).

4. The method as set forth in claim 1 wherein said number s computed in the step (a) is computed from a relationship of s=g^{z}w mod p (g is a primitive element of the group and order(g)=q, p is a prime integer with p=2q+1, q is a large prime number).

5. The method as set forth in claim 1 wherein said number Bᵢ (i=1, . . . , n) of the step (b) is computed from a relationship of Bᵢ=(s)^{x}^{ᵢ} mod p (p is a prime number, p=2q+1, q is a large prime number).

6. The method as set forth in claim 1 wherein said authentication key K of the step (c) is computed from a relationship of
$$K = KDF ( ( {\prod }_{i = 1}^{″} {B}_{i} ) / {y}^{z} mod p )$$
(p is a prime integer, p=2q+1, q is a large prime number) where KDF ( ) is a function for computing an authentication key.

7. The method as set forth in claim 1 wherein less than all of Bᵢ (i=1, . . . , n) are required to compute said authentication key K of the step (c).

8. The method as set forth in claim 1 wherein said step (a) comprises a step of transmitting (A, s) to each key server KSᵢ (i=1, . . . , n) where A is an identifier of said user and s is computed from a randomly selected number z (1≦z≦q−1) and w (=f(PWD)) in which f maps said secret data PWD to elements of multiplicative order q in Zₚ*.

9. An authentication system for producing an authentication key K from a secret data PWD that can be memorized by a user from a set of private keys x₁, . . . , xₙ of each key server KS₁, . . . , KSₙ and a public key y of the group KS₁, . . . , KSₙ, comprising:
a multiple of key server KSᵢ (i=1, . . . , n) that individually computes Bᵢ (i=1, . . . , n) from its own private key xᵢ (i=1, . . . , n) and the number s that has been sent from a user's terminal, and transmits said Bᵢ to the user's terminal; and
said user's terminal that computes an authentication key K from Bᵢ (i=1, . . . , n) and the public key y of the group of said key servers.

10. The system as set forth in claim 9 wherein w=f (PWD) is computed from said secret data PWD and a function f while s=g^{z}w mod p is computed from a randomly selected number z (1≦z≦q−1)(g is a primitive element of the group, order (g)=q, p is a prime integer and p=2q+1, q is a large prime number).

11. The system as set forth in claim 9 wherein Bᵢ, which is transmitted from said key server KSᵢ (i=1, . . . , n), is computed from a relationship of Bᵢ=(s)^{x}^{ᵢ} mod p (xᵢ is a private key of said key server KSᵢ (i=1, . . . , n))

12. The system as set forth in claim 9 wherein said authentication key K is computed from a relationship of
$$K = KDF ( ( {\prod }_{i = 1}^{n} {B}_{i} ) / {y}^{z} mod p ) .$$

13. The system as set forth in claim 9 wherein less than all of Bᵢ (i=1, . . . , n) are required to compute said authentication key K.
